(19) United States
(12) Patent Application Publication
(10) Pub. No.: US 2023/0267543 A1
(43) Pub. Date: Aug. 24, 2023

(54) TRACKABLE PRODUCT INTEREST SYSTEM AND METHOD

(71) Applicant: SKUewy, LLC, Kamuela, HI (US)

(72) Inventors: Troy Brost, Kamuela, HI (US); Dan McElhattan, III, Kamuela, HI (US); Craig H. Macy, Reno, NV (US)

(21) Appl. No.: 18/099,205

(22) Filed: Jan. 19, 2023

Related U.S. Application Data
(60) Provisional application No. 63/400,613, filed on Aug. 24, 2022.
(60) Provisional application No. 63/313,444, filed on Feb. 24, 2022.

(51) Int. Cl. G06Q 40/06

(52) U.S. Cl. CPC G06Q 40/06

(57) ABSTRACT

A computer implemented process for raising capital with asset identifiers. The process includes scanning or otherwise providing into storage an asset identifier for an asset including a product and/or service provided by a providing entity, storing an association between the asset and the asset identifier, and offering for sale at least a portion of the asset identifier ownership along with at least a percentage interest in subsequent sale revenue or other derived asset value as applicable. The process can include providing an associated contractual obligation of delivery to or for a purchaser of the percentage interest of subsequent sale revenue or other valued derived from the asset, and providing to the providing entity at least an apportionment of the sale revenue or other value for the sale. The asset identifier can include a barcode, SKU, or other identifier; and the process may be automated in whole or in part.

### COPYRIGHT

A portion of the disclosure of this patent document contains material subject to copyright protection. The copyright owner has no objection to the exact reproduction by anyone of the entire patent document or entire the patent application, as it appears in the Patent and Trademark Office patent file or records, but otherwise reserves all copyright rights whatsoever.

### CROSS REFERENCE TO RELATED APPLICATIONS

This application claims priority to the applicant’s prior U.S. Provisional Application, titled “System And Method For Providing Interest In Future Revenue From Trackable Products,” Serial No. 63/313,444, filed, Feb. 24, 2022, and applicant’s prior U.S. Provisional Application, titled “Trackable Product Interest System And Method,” Serial No. 63/400,613, filed, Aug. 24, 2022, which applications are hereby incorporated by reference in their entirety. In the event of any inconsistency, however, between such provisional applications and this non-provisional application, this non-provisional application shall govern.

### FIELD OF DISCLOSURE

This application relates to a system and method providing to a third party an interest in one or more future product or service transactions, such as, for example, trackable product or service sales or leases, and more particularly, a system and method for providing business capital by sale of percentage interest in transactions involving identified products or services of the business seeking the capital.

### BRIEF ASPECTS OF THE BACKGROUND OF THIS SPECIFICATION

Raising business capital has long relied primarily on dilutive, financially constraining, and/or administratively burdensome financing vehicles, such as loans, selling stock, selling business assets, and the like. Similarly, government, legal, and financial institutions, and escrow agencies have long been closely involved to, in part, facilitate and create trust in processing these capital-raising transactions and other transactions.

While these traditional burdensome systems have worked for certain business, such as larger manufactures and large service providers, they nevertheless typically suffered from one or more of lack of flexibility, heavy administrative burdens, lack of speed, scalability, and the inherent weaknesses in depending heavily on trust-based models. Further, they have often been illsuited to address the financial needs of smaller companies across the supply chain, and were typically either directly tied to rights in company assets intended for sale or lease to third party customers, provided as dilutive equity with one or more preference unfavorable to the company, or both. This often resulted in encumbering assets such that they were less useful to the business, creating cumbersome governance and control mechanics for the doing of business, or both..

Business owners typically have had limited or no means of creating, tracking, and selling of rights to specific product or service revenue to raise capital, and investors have had limited or no ability to readily purchase such rights, generate cashflow or other value through such a purchase, and to consequently reap the rewards of such a purchase without the burdens of establishing business ownership, establishing an equity position, or engaging in otherwise complex, inefficient, and time-consuming conventional transactions.

When businesses require capital influx, however, they often urgently need the capital without delay, or in a fashion that cannot unwind the capital raise transaction. One example for why this is often so is because institutions involved in these transactions typically have been unable to guarantee the avoidance of disputes and related dispute resolution processes. As a result, the cost of disputes and dispute resolution typically resulted in one or more of increasing transaction cost, such as through near-usurious interest rates, limiting scalability of transactions, and cutting off the possibility for smaller transactions, much less, large numbers of such smaller transactions.

The resulting lack of speed, scalability, and small transaction accommodation, and the frequently inherent and substantial cost and trust issue in transactions, within traditional capital raising systems not only have reduced the amount of capital available to business across the supply chain, but also typically have precluded investors from providing businesses with efficient payments for product or service ownership rights, including non-reversible payments for non-reversible product or service ownership rights, and accompanying value and revenue therefrom.

### BRIEF SUMMARY OF CERTAIN ASPECTS OF THIS SPECIFICATION

The inventors believe that they have discovered at least some of the problems, and at least the severity of the problems, identified in the Background section above as well as advantages variously provided by differing embodiments of the trackable product interest system disclosed in this specification.

The applicants have therefore invented a system and method for business or others to raise capital by selling a percentage of interest in one or more derived assets, with investors thereby accessing and acquiring a percentage of ownership rights in, and subsequent product or service sales revenue or other value derived from such product or service, resulting in, among other things, an improvement to the technical fields of tracking assets and associated value events, monetizing derived assets. ensuring transaction integrity assurance, and automated financing systems.

Some embodiments provide for procuring investment for an entity through the entity selling full and/or fractional ownership of one or more of (i) the entity’s product or service identifiers, such as, stock-keeping units SKU’s, barcodes, and the like, and (ii) the revenue or other value derived through product or service related transactions, such as the entity’s or another’s subsequent sale or leasing of the product or service having the product or service identifiers, with the subsequent use of the product or service identifiers being used to one or more of identify the transaction, report the transaction to the entity and investor, and arrange resulting required payment or value transfer to the interest-ownership purchaser from the transaction. Some embodiments may use product or service identification and tracking techniques in addition to, or other than, SKU’s and/or barcodes, collection identifiers representing multiple child identifiers, or both.

Some embodiments may be automated and provide digital assets, such as tokens, and in some applications non-fungible tokens, representing such ownership. Some embodiments may do so using digital ledger or other token generation, token exchange, and related transaction management systems and methods.

Some embodiments provide an online marketplace platform based, at least in part, on blockchain cryptographic proof and trust, allowing two or more willing parties to instantly transact directly with each other without the need of a trusted third party. In some applications, said parties can buy, sell, or own fractional or full interest of a product identifier or group of identifiers attached to any good or service offered for sale within the open market. In some embodiments, transactions that are computationally impractical to reverse can protect all parties from fraud, and optionally, automated smart contracts and token services can protect both token buyers and token sellers from one or more of fraud, delays, or disputes. Some systems can utilize existing and future SKU’s, barcodes, manufacturer product numbers, or similar product or service identification and tracking solutions and technologies to provide or facilitate ongoing distribution of derived asset value, such as tracked product or service revenue (or other value), which optionally can be near-instantly or batch processed and securely settled within the system or systems that may cooperatively provide the overall platform.

Some embodiments can provide an alternative for a business or other entity to raise capital without one or more of leverage (debt), excessive-regulation, partnerships, selling company equity or entity membership interest, or relinquishing identity or control, in conjunction with an alternative for investors to directly purchase a percentage of ownership rights in derived asset value, such as that of established or other revenue generating product(s) or service(s), offering protective features similar to those of the business selling the product(s) or service(s), in lieu of, or in addition to, other vehicles of raising capital, such as, for example, selling business stock or entity membership interest. In some applications, these processes can including providing smart contracts administered by trusted vehicles, such as by blockchain for example.

In some embodiments, these processes can be provided in whole or in part by one ore more automated systems, which in some embodiments can provide significant trust, such as through use of a blockchain implementation for example, and optionally can economically and quicky perform the processing and transactions required to provide business capital by sale of percentage interest in derived asset value, such as a percentage interest in the revene generated from transaction in identified products or services of the business seeking the capital.

The identifier-based approach of the trackable product interest system approach disclosed herein can improve the efficiency of one or more of the tracking of assets, monetization of events associated with identifier-associated asset transactions, and investment in derivative asset value. Participants may be able to skip one or more steps that they would normally have to go through in order to one or more of offer fractional interests in derived asset value, purchase fractional interests in derived asset value, and settle and distribute proceeds of derived asset value transactions.

Further, the identifier-based approach can memory demands by more efficiently representing and maintain the asset-to-identifier-to-participant relationships, along with the inclusion of attributes across multiple layers of the identifier hierarchy, such as, for example, the combination of embedded attributes, related metadata values, and one-to-many relationships.

Implementations that include digital ledger technologies can reduce inaccuracies, increase trust, and improve security, and increase reliability due in part to on-chain immutability, encryption, redundancy, and the like. Bandwidth usage can be reduced due at least in part to the elimination of numerous intermediary steps associated with traditional approaches. The identifier approach can remove the need for retailers and distributors to prepare and distribute complex and lengthy reports as part of the settlement process, further reducing memory, processor, and bandwidth demands.

The accuracy of the investment returns can be improved due at least in part to the automated nature of collecting and tracking identifiers, such as through the use of scanning technologies, the maintaining of identifier-to-asset associations through, for example, system rules and smart contracts, and association of metadata attributes both as part of an identifier as well as a through a relationship to an independent data element.

The foregoing summary is illustrative only and is not intended to be limiting. Other aspects, features, and advantages of the systems, devices, and methods and/or other subject matter described in this application will become apparent in the teachings set forth below. The summary is provided to introduce a selection of some of the concepts of this disclosure. The summary is not intended to identify key or essential features of any subject matter described herein.

The systems, methods and devices described herein have innovative aspects, no single one of which is indispensable or solely responsible for their desirable attributes. Without limiting the scope of the claims, some of the advantageous features will be summarized.

For purposes of summarizing the disclosure, certain aspects, advantages, and features of the inventions have been described herein. Not all, or any such advantages are necessarily achieved in accordance with any particular implementation of the inventions disclosed herein. No aspects of this disclosure are essential or indispensable. In many implementations, the devices, systems, and methods may be configured differently than illustrated in the figures or description herein. For example, various functionalities provided by the illustrated modules can be combined, rearranged, added, or deleted. In some implementations, additional or different processors or modules may perform some or all of the functionalities described with reference to the example implementation described and illustrated in the figures. Many implementation variations are possible. Any of the features, structures, steps, or processes disclosed in this specification can be included in any implementation.

Consequently, the scope of the invention is not to be determined by whether it includes a feature or advantage because it is recited in the Background or Summary sections but rather by the scope of the claims as issued.

### BRIEF DESCRIPTION OF THE FIGURES

In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

The inventors’ preferred and other embodiments, and additional aspects of the nature and advantages of the present disclosure, are disclosed in association with the following Figures, in which:

FIG. 1A through FIG. 1C is a block diagram of an architecture supporting the trackable product interest system, including a cloud-based, back-end infrastructure;

FIG. 2 is a block diagram of distributed ledger technologies of FIG. 1A through FIG. 1C in communication with the backend system and services of FIG. 1A through FIG. 1C;

FIG. 3 is a block diagram of oracles of FIG. 1A through FIG. 1C in communication with the disturbed ledger technologies of FIG. 1A through FIG. 1C and the off-chain services of FIG. 1A through FIG. 1C;

FIG. 4 is a block diagram of an oracle node of FIG. 3 in communication with the disturbed ledger technologies of FIG. 1A through FIG. 1C and the backend system and services of FIG. 1A through FIG. 1C;

FIG. 5 is a block diagram of the services layers of the trackable product interest system of FIG. 1A through FIG. 1C;

FIG. 6 is a block diagram of the services and engines of the services layers of FIG. 5 performing the various operations of the trackable product interest system of FIG. 1A through FIG. 1C;

FIG. 7 is a block diagram of a tokenized asset identifier hierarchy;

FIG. 8 is a block diagram of an asset identifier hierarchy;

FIG. 9 is a block diagram of a SKU-centric asset identifier hierarchy implementing the asset identifier hierarchy of FIG. 8;

FIG. 10A through FIG. 10H are a series of diagrams of various tables of the trackable product interest system supporting various asset identifying functions;

FIG. 11A through FIG. 11F are a series of diagrams of various tables of the trackable product interest system supporting various asset transaction functions;

FIG. 12A through FIG. 12C are a series of diagrams of various tables of the trackable product interest system supporting various payment functions;

FIG. 13 is a flowchart of the various operations and activities performed by the services layers of FIG. 5 in the trackable product interest system of FIG. 1A through FIG. 1C in communication with the store components in FIG. 1A through FIG. 1C;

FIG. 14 is a flowchart of the various operations and activities performed by the services layers of FIG. 5 in the trackable product interest system of FIG. 1A through FIG. 1C;

FIG. 15 is a flowchart of the various operations and activities associated with revenue-generation activity in the trackable product interest system of FIG. 1A through FIG. 1C;

FIG. 16 is a flowchart of the various operations and activities associated with identifier creation activity in the trackable product interest system of FIG. 1A through FIG. 1C;

FIG. 17 is a flowchart of the operations, activities, and algorithmic-rules associated with payment activity in the trackable product interest system of FIG. 1A through FIG. 1C;

FIG. 18 is a flowchart of the various operations and activities associated with tokenization activity in the trackable product interest system of FIG. 1A through FIG. 1C;

FIG. 19 is a flowchart of the various operations and activities associated with fractional tokenization activity in the trackable product interest system of FIG. 1A through FIG. 1C;

FIG. 20 is a flowchart of the various operations and activities associated with store activity in the trackable product interest system of FIG. 1A through FIG. 1C;

FIG. 21 is a flowchart of the various operations and activities associated with store activity involving the use of a scanning device in the trackable product interest system of FIG. 20; and

FIG. 22 is a block diagram of a computer system suitable for implementing the operations of the trackable product interest system as part of FIG. 1A through FIG. 1C.

### DESCRIPTION OF THE PREFERRED AND OTHER EMBODIMENTS

The various features and advantages of the systems, devices, and methods of the technology described herein will become more fully apparent from the following description of the implementations illustrated in the figures. These implementations are intended to illustrate the principles of this disclosure, and this disclosure should not be limited to merely the illustrated examples. The features of the illustrated implementations can be one or more of modified, combined, removed, or substituted as will be apparent to those of ordinary skill in the art upon consideration of the principles disclosed herein.

The system and methods are made effective through the association of certain rights, such as rights to derived asset values (e.g., generated revenues) rather than, or in some cases in combination with, the sale of a specific product or asset, with one or more identifiers and the value generated through transactions involving the products or assets associated with the one or more identifiers. The identifier can be immutable and represent a set of products or assets, where such products or assets may be altered or varied over time, such as by being changed, updated, upgraded, and improved.

Converting assets and ownership rights into digital asset representations, such as tokens, and recording the transaction(s) on a distributed ledger, such as a blockchain, is a technology process known as tokenization. In some embodiments, the trackable product interest system is a component of marketplace to facilitate these transactions, improving the performance, reducing the cost, and easing the demands of compliance and scalability to achieve ongoing distribution of sale proceed ownership payments.

A SKU is a scannable bar code. SKUs are generally printed on retail product labels, allowing vendors to automatically track inventory. The SKU is composed of an alphanumeric combination of eight-or-so characters providing a code to track product price, product details, and the manufacturer. SKUs may be applied to any billable product or service.

As an example, a store selling a widget creates an internal SKU detailing product attributes, such as the product color, size, style, price, manufacturer, brand, etc. SKUs can facilitate the collection of sales data. Because companies internally create SKUs to track inventory, SKUs for identical products vary among businesses. Differing SKUs assist retailers to design advertising campaigns without vendor interference. In contrast, yet important to product sales, Universal Product Codes (UPCs) are 12 numeric digits and identical for a given type of product regardless of which business is selling the items.

In some implementations, there are varied processes depending on, at least in part, a participant’s role.

With respect to a token seller role, for example, a token seller desires to sell ownership rights attached to an identifier, such as a collection identifier or an asset identifier,such as aSKU/Barcode. In some instances, the trackable product interest system generates or initiates the generation of a smart contract, such as an exclusive non-compete smart contract agreement, and a number of fractionalized digital tokens, such as, for example, some number of ERC-20 tokens, attached to said SKU/Barcode.

In some instances, via, for example, a smart contract or other mechanism, the retailer, distributor, or provider of the products or service associated to the collection identifier or SKU/Barcode agrees to continue selling the product or services, such as for a minimum agreed amount of time, and to maintain the collection identifier or SKU/Barcode associated with the product or service as a unique identifier for the associated product or service unless and until a certain ownership percentage is obtained by the provider of the products or service, such as, for example, 100% ownership of said SKU/Barcode by the provider of the products or service.

Based, at least in part, upon one or more factors, such as, for example, the provider of the products or service prior sales and revenue data of the products and services associated with the collection identifier or SKU/Barcode offered for sale, the trackable product interest system determines estimated token values based on various rates of return a purchaser might expect. This could be calculated, for example, by multiplying the percent ownership represented by the token value by the prior sales and revenue totals for a period of time. The provider of the products or service can assign a token value where the number of fractional tokens multiplied by the token value represents the 100% ownership value of that collection identifier or SKU/Barcode. The provider of the products or service can, in some cases, provide the quantity of tokens offered for sale, where that amount represents the percentage of ownership of the collection identifier or SKU/Barcode offered for sale.

In some instances, the pro rata portion of the derived asset value represented by the fractional collection identifier or SKU/Barcode determines, at least in part, the portion of proceeds to be distributed to the token owner or token owner beneficiary, and therefore the apportionment of the sale revenue or other value for the sale to the provider of the product or service. Where distributed derived asset value is a function of asset-related revenue, such as sales revenue, distribution to the owner or owner beneficiary can occur on or after the sale of one or more products and services associated with the collection identifier or SKU/Barcode, such as via a distributed ledger system, a digital ledger system integrated with a payment system.

In some embodiments, certain token sellers, token distributors, or providers of the products or services associated with the collection identifier or SKU/Barcode have a first right of refusal, such as a 72-hour first right of refusal, to repurchase any such identifier-associated token re-listed for sale by a party who earlier acquired the token.

After certain periods of time, such as, for example, every 180 days, through the trackable product interest system, the distributor of the product associated with the collection identifier or SKU/Barcode may notify other holders of that collection identifier or SKU/Barcode of their interest in purchasing back any portion of the ownership rights to that collection identifier or SKU/Barcode. This can be an anonymous notification to all other holders of an interest in that collection identifier or SKU/Barcode and follows the typical buy/sell system protocols, but typically would not be in competition with the open market.

With respect to a token buyer role, for example, multiple token buyers of a tokenized collection identifier or SKU/Barcode can be permitted on a first come first sold basis. In some implementations, token buyer’s may either indicate their desired token quantity and select a set token price offered by the token seller, or otherwise provide both their desired token quantity and an offer price. A negotiation and settlement between the token buyer and the token seller may occur with certain limitations, such as, for example, a maximum number of iterative offers, such as three offers. In some instances, the token buyer may indicate to the token seller that this offer is their best and final offer, where if the best and final offer is not accepted by the token seller, or no offer is accepted within the maximum number of negotiations, the token buyer is prevented from negotiating on that collection identifier or SKU/Barcode for a number of days, such as 30 days. In some cases, the token buyer continues to have the option to purchase the collection identifier or SKU/Barcode at the price set by the token seller. In some implementations, the trackable product system includes or is integrated with a token exchange system an interface which provide one or more of these features or functions.

In some implementations, one or more system fees are collected, such as by charging the token buyer, token seller, or both, a transaction fee, charging token holder’s a fee determined as a percent of the value of the total collection identifiers or SKU/Barcodes managed, or the like.

Payments to token holders may vary based on the payment arrangements between the provider of the products or service associated with the collection identifier or SKU/Barcode and the retailer, distributor, or seller of the associated products or services. In some cases, payment is made when the retailer, distributor, or seller of the associated products or services makes the purchase order. In other cases, such as with larger retailers, payments may be made after a maximum number of days, such as 90. In yet another case, payment is made after a point in time where the sale of the product or service achieves a non-refundable state. In some implementations, payments are made to holders directly. In some instances, payments are made as a function of a smart contract. In some instances, as a condition of payment, the smart contract will verify one or more off-chain events, such as through an oracle.

In some embodiments, the trackable product interest system is implemented, in part, on a permissioned distributed ledger framework, such as the Hedera private network built on Hyperledger Fabric, which can support the issuance of tokens for sale. In some instances, the token is a fractionalized token, such as a non-fungible token, representing fractional or full ownership of one or more specific collection identifiers or SKU’s/Barcode’s where only permissioned token sellers and token buyers can participate. A network administrator or participants of the permissioned distributed ledger framework can create a topic ID and communicate the ID to participants on the network. Participants can then recognize both the network and token associated with the transaction.

When a token seller transfers a token to a token buyer, the permissioned distributed ledger framework can automatically hash the transaction ID, submit it in the transaction message payload, and specify the exact topic. Users can sign the transaction through the client application and add it to the public network.

In some instances, the permissioned distributed ledger framework system can automatically complete the transfer between users, recording a fair and final consensus timestamp of when the transaction occurred. The permissioned distributed ledger framework can determine transfer order, which might be invalid, timestamp depending. In some instances, permissioned distributed ledger framework supports atomic swaps of tokens between networks.

In order to exchange tokens, token sellers and token buyers can be participants in each network. Tokens can be locked in a smart contract deployed in each network. This can involve signatures from both token sellers and token buyers, and a timestamp from a transaction on the permissioned distributed ledger framework. Token sellers and token buyers can agree to unlock (transfer) the tokens to the new holder at the same time, initiated by a transaction sent to a consensus service, such as the Hedera Consensus Service, and returned with a consensus timestamp. In the case of Hedera, the Fabric-Hedera protocol enables permissioned asset trading through a decentralized private network, offering trust and immutability of the Hedera public network. Hedera is free of transaction manipulation order by a centralized party, and the permissioned distributed ledger framework can sustain downtime because of the presence of individual network nodes.

In some implementations, the collection identifier or SKU/Barcode are not altered, reused, or both. This can be enforced, at least in part, through one or more smart contracts. The trackable product interest system can use the collection identifier or SKU’s/Barcode’s for both token sellers and token buyers to attach the listing and ownership with their individual inventory level within the trackable product interest system. In some instances, products have a unique collection identifier or SKU/Barcode, a new record is created in the trackable product interest system whenever a new collection identifier or SKU/Barcode is uploaded, each record is unique and existing collection identifier or SKU/Barcode cannot be changed, collection identifiers and SKU’s/Barcode’s remain in the trackable product interest system until deleted by all holders of that collection identifier or SKU/Barcode, and most recent data replaces data attached to a previous collection identifier or SKU/Barcode when a provider of the products or service provides an inventory, such as by uploading an inventory file, with data for the collection identifier or SKU/Barcode. Data updates do not affect existing ownership contracts.

In some embodiments, the trackable product interest system involves allowing the provider of the products or service to provide the Standard Product Identifier, such as the UPC, EAN, JAN, or ISBN when creating a new product element on the trackable product interest system. Token buyers can use search terms to find products on the trackable product interest system. In some implementations, each collection identifier or SKU/Barcode can be associated with keywords.

In some implementations, the trackable product interest system transactions depart from point-of-sale transactions because the sale and purchase of any collection identifier or SKU/Barcode creates an ongoing, arms-length relationship between the token seller and token buyer. The offer is for ownership rights in asset value derived from transactions and events, such as, for example, revenue from product sale. The transaction can include a measure of vetting, such as vetting of identities to further improve confidence in the integrity of the transaction. Services within the trackable product interest system can verify pertinent facets of trust sought between token buyer and token seller. The token buyer or token seller may not know specific details of who each other are, or directly communicate with each other. The token seller can be protected in anonymity and be free to operate their business as usual, without traditional problems related to investor or partner direction or interference. The token buyer can be protected in anonymity and can become a collateralized or uncollateralized asset holder without typical business liabilities, responsibilities, or both. The trackable product interest system verifies and electronically clears token buyer funds into the token seller account prior to the token seller collection identifier or SKU/Barcode percentage sale transferring to the token buyer account. The electronic transfer of the collection identifier or SKU/Barcode associated token can occur immediately after the clearing of token buyer funds. One or more of the above can contribute to improved security while maintaining necessary levels of privacy.

Assisting token buyers in their assessment of a potential purchase of a collection identifier or SKU/Barcode, the trackable product interest system can verify one or more of that the product or service provider owns the rights to, and is selling, the product or service attached to the collection identifier or SKU/Barcode, and can further verify product or service provider historic sales data on the product or service associated to the tokenized collection identifier or SKU/Barcode offered for sale. In some embodiments, the trackable product interest system can provide one or more of business verification, such as confirmation of registered details and legal status of a business, verification of the credit score and maximum recommended credit limit of a business, business financial data, verification of the business directors, business ownership verification, and de-risking information, such as confirming if the business or suppliers have late or missed payments, or the presence of any court judgements.

In some embodiments, the provider of the products or service agrees through a smart contract or alternative instrument, such as a collateralized instrument, to continue selling the product attached to the collection identifier or SKU/Barcode until the token buyer recovers 100% of their purchase expense, plus a minimum percent return over the purchase price, such as 10%, for example.

The trackable product interest system online interface can function with many similarities to eCommerce sites such as amazon.com, crexi.com, shopify.com, and others, including one or more of search filter criteria, automated financial calculations, high quality graphics, dynamic membership/subscriber secure portals, detailed reporting, simplified payment systems, and the like. The interface can further include one or more of web-friendly fonts, multiple languages, recognized terms, animation, icons, visual graphics elements, white space, validation feedback of forms and fields, data entry user cues, and accessibility features such as type-ahead lists, calendar pickers, and pop-up dialogs when appropriate.

In some embodiments, the trackable product interest system offers secure, interactive customer portals. Customer portal features can include one or more of secure 24/7 self-service from various end devices, order placement, payment, and management, the ability to add custom product branding, statement and year-end tax document generation, multi-currency and high load volume support, ability to embed into websites, ability to read/write information, custom cascading style sheet options, data integration in multiple business systems, single sign-on, encryption, LDAP, expiration policies of passwords, IP whitelists, payments and remittance.

In some instance, one or more components of the trackable product interest system is node based. In order to operate within a decentralized network, public distributed ledger technologies typically have computers acting as nodes. Nodes can serve multiple purposes, including providing a copy of the ledger of the balances in every network user account and verification and execution of new transactions, placing those transactions into consensus order. User account balances can be updated on an ongoing basis. Nodes can provide computing power to perform consensus algorithms and process transactions within the network. Public distributed ledger technologies generally financially compensate node hosts in effort to incentivize participation.

In the case of Hedera, Hbars are used to pay for network services, such as submitting transactions, fulfilling smart contracts, storing files, using the Hedera Consensus Service, and to financially reward node hosts for providing their computing resources to the Hedera network. Transaction fees can be low, such as one one-hundredth of a cent, for example, therefore offering Hbar micropayments divisible by less than a penny.

Further in the case of Hedera, as part of creating efficient flow of funds, Hedera transactions balance costs and incentives. This flow consists of end user or third-party transaction fee payments into a Hedera account, and node host financial rewards from a Hedera-controlled account.

The trackable product interest system can operate node(s) on a variety of distributed ledger and payment systems, and is not limited to Hedera or any particular vendor or technology.

The trackable product interest system can provide a system of electronic transactions without necessarily relying on conventional, trust-based transaction techniques, though use of such techniques may be utilized as desired to supplement the trackable product interest system electronic transactions. Utilizing, for example, the Hedera Consensus Service, the trackable product interest system can offer trusted, fast, fair, secure, and/or decentralized consensus to the buying and selling of fractional to full transactions of collection identifiers SKU’s/Barcodes, creating a means of transferring ownership rights and product point-of- sale proceeds attached to the collection identifier or SKU/Barcodes through issuance and the exchange of tokens, by using the fair global ordering of transactions. In some instances, and external payment system or method is triggered instead of token distribution.

Many different systems can implement the method of the trackable product interest system. Moreover, the steps of the present method could occur at different parts of a system, at a single part of a system, in parallel across the system, or in any other fashion. Moreover, certain embodiments of the trackable product interest system are described with reference to methods, apparatus (systems) and computer program products that can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the acts specified herein to transform data from a first state to a second state.

These computer program instructions can be stored in a computer-readable memory that can direct a computer or other programmable data processing apparatus to operate in a particular manner, such that the instructions stored in the computer-readable memory produce an article of manufacture including instruction that implement the acts specified herein.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the acts specified herein.

The various illustrative logical blocks, modules, circuits, and algorithm steps described in connection with the embodiments disclosed herein can be implemented as electronic hardware, computer software, or combinations of both. The various illustrative logical blocks, modules, and circuits described in connection with the embodiments disclosed herein can be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but in the alternative, the processor can be any conventional processor, controller, microcontroller, or state machine. A processor can also be implemented as a combination of computing devices, e.g., a combination of a DSP and a microprocessor, a plurality of microprocessors, one or more microprocessors in conjunction with a DSP core, or any other such configuration.

The blocks of the methods and algorithms described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, a solid state drive, a hard disk drive, a removable disk, a CD-ROM, or any other form of computer-readable storage medium known in the art. An exemplary storage medium is coupled to one or more processors such that the processor can read information from, and write information to, the storage medium. In the alternative, the storage medium can be integral to the processor. The processor and the storage medium can reside in an ASIC. The ASIC can reside in a user terminal. In the alternative, the processor and the storage medium can reside as discrete components in a user terminal.

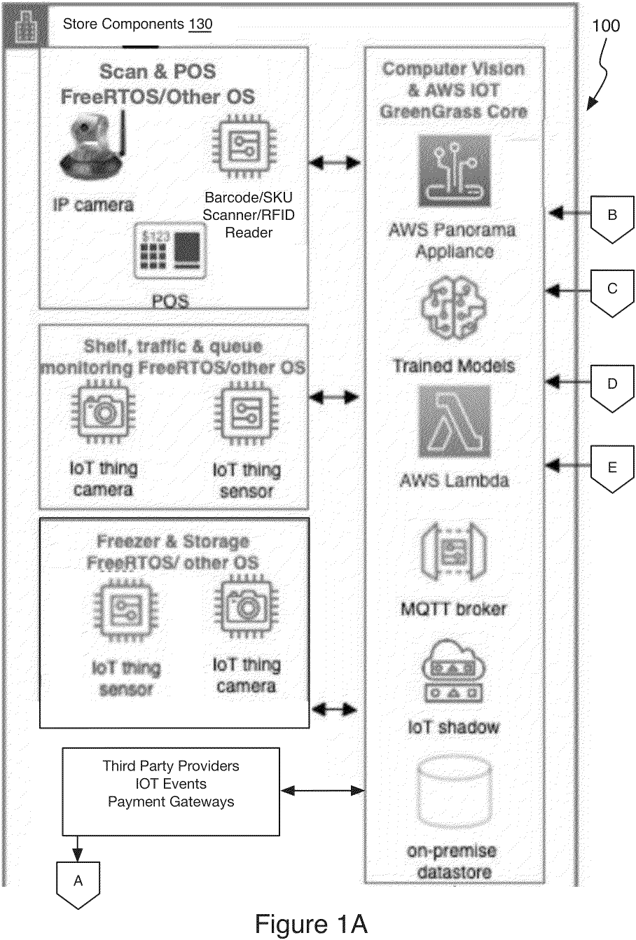

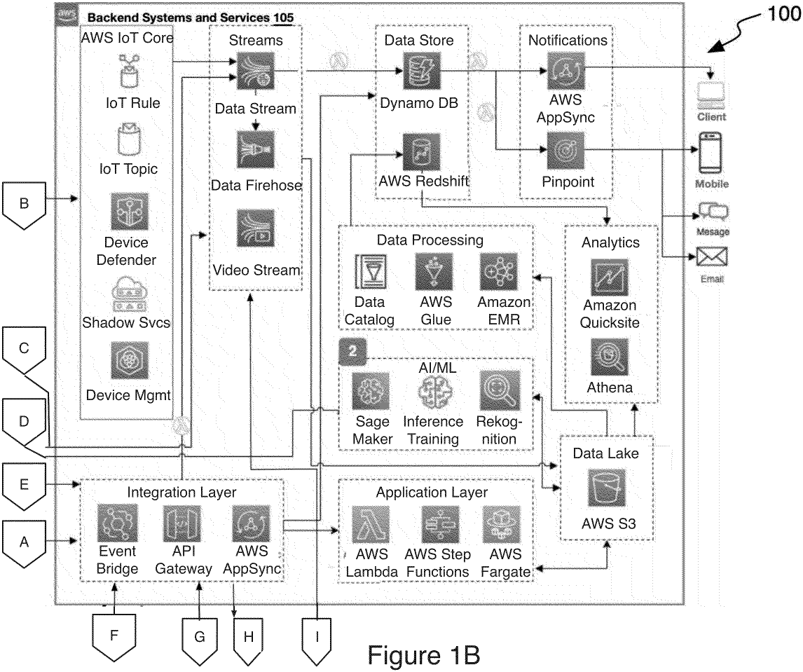

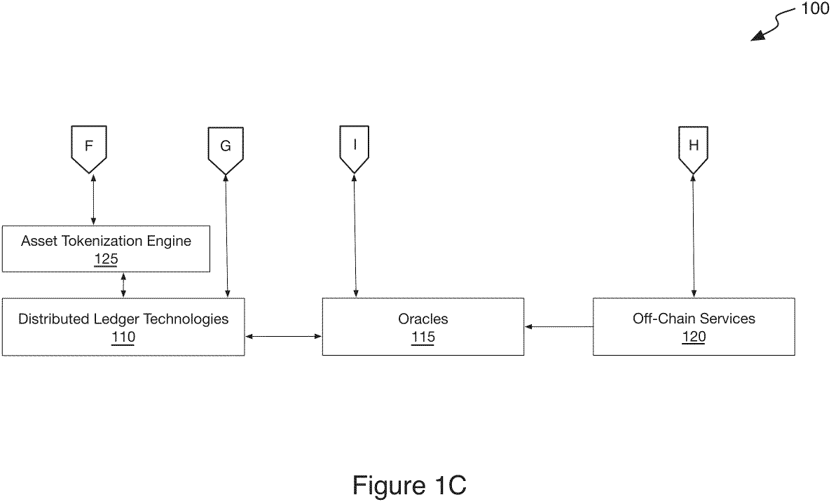

Referring now to FIG. 1A, FIG. 1B, andFigure 1C, one embodiment of the trackable product interest system includes back-end system and services 105. In some instances, the trackable product interest system further includes one or more of store components 130, and asset tokenization engine 125, distributed ledger technologies 110, oracles 115, and off-chain services 120. In some implementations, at least a portion of the trackable product interest system includes a set of cloud services. In some instances, the back-end system and services 105 include one or more of IOT core services, streaming data services, a persistent data store, notification services, analytics and reporting services, an application layer, an integration layer, a data lake, and data processing services. In some instances, the store components include one or more of identifier activity collection technologies, such as scanners, point of sale systems, sensors, cameras, shelf monitoring technologies, and the like. In some instances, store components further include on-premise edge technologies, such as AWS GreenGrass.

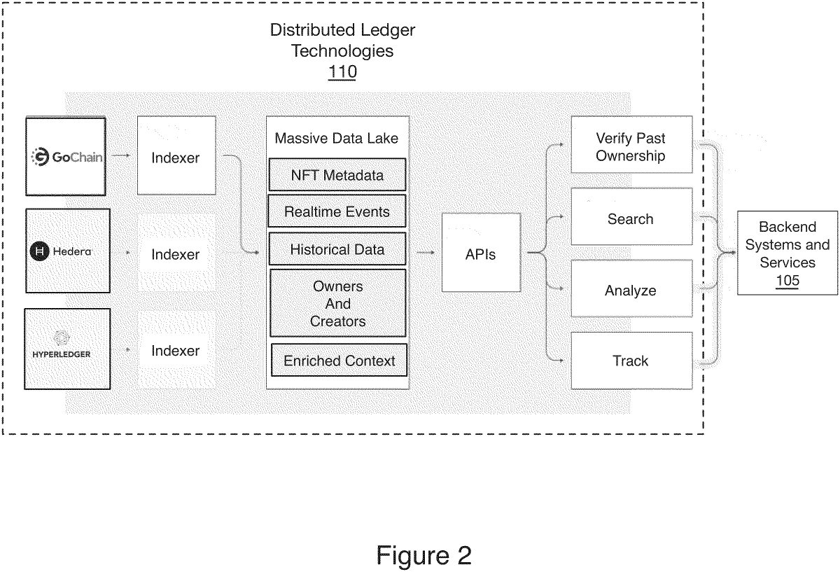

Referring now to FIG. 2, in some embodiments, the trackable product interest system includes one or more digital ledger technologies 110, such as the Hedera Consensus Service, the GoChain network, Hyperledger, or the like. The Hedera Consensus Service, for example, can provide high degrees of customization, control, and establish public trust for a permissioned tokenized asset network. Through tokenization and the use of the Hedera Hashgraph network consensus algorithm, the trackable product interest system can offer anonymity token buyers, token sellers, or both, and can provide a decentralized, high-throughput, low-latency solution with predictable or semi-predictable fees. The trackable product interest system can operate safely and efficiently, while incentivizing and benefitting both entrepreneurs and businesses.

In some implementations, the digital ledger platform, such as the GoChain platform, Hedera platform, or Hyperledger platform populate a data lake, via an indexer, that can contain, for example, non-fungible token metadata, real-time event information, historical data, owner information, and context information. An API interface can be made available to the backend systems and services 105 to provide service such as, for example, verification of ownership, search, analytics, tracking, and real-time information.

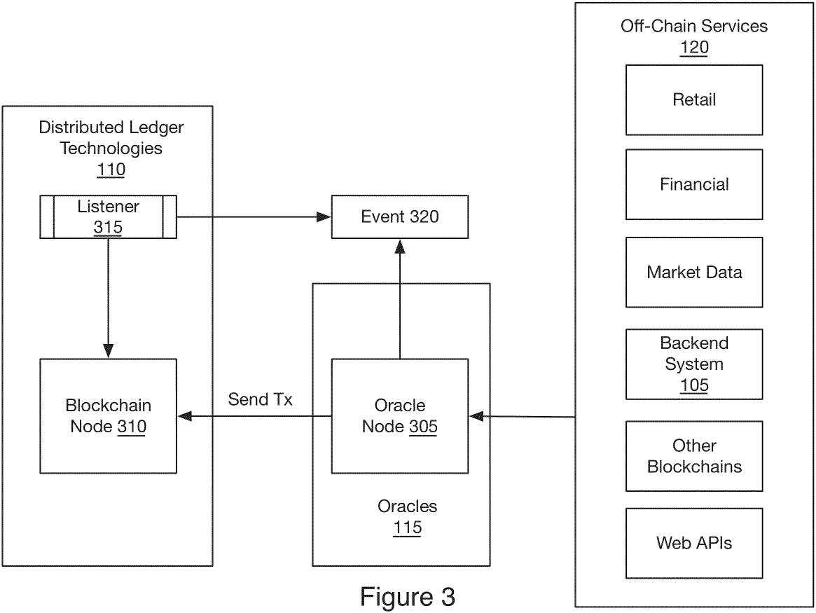

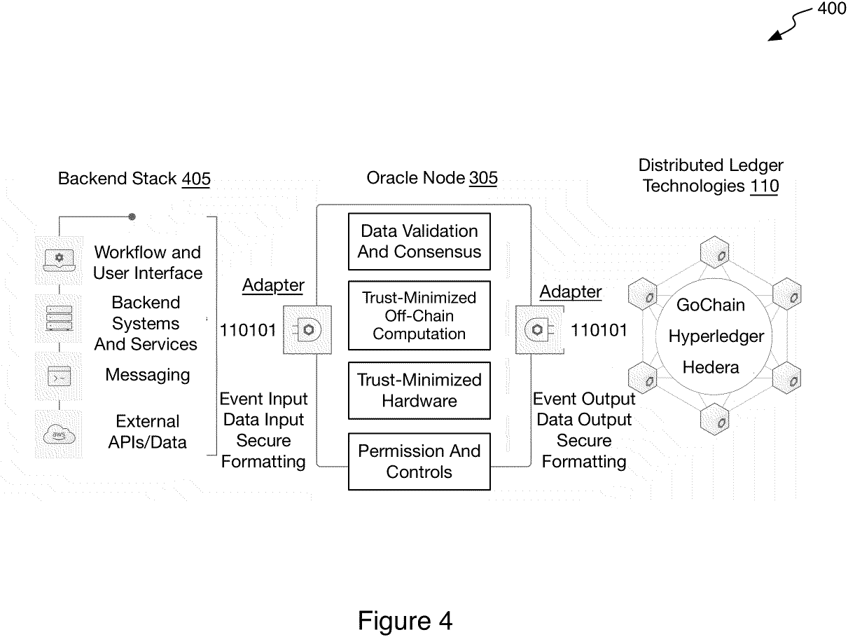

Referring now to FIG. 3 and FIG. 4, in some implementations, off-chain services 120 provide information to the distributed ledger technologies 110 via one or more oracle nodes 305. In some instances information is pushed directly into the distributed ledger technology 110 from the oracle node 305 via a blockchain node 310. In other instances, the distributed ledger technology operates or interfaces with one or more listeners 315 that listen for published events 320 published by the oracle node 305 base, at least in part, on information obtained from an off-chain service. Off-chain services can include, for example, retail systems, financial systems, market data services, other blockchains, web API interfaces, as well as the trackable product interest system backend system and services 105. This configuration can allow for the triggering of smart contracts on the distributed ledger technology based on off-chain events. Referring now to FIG. 4, the oracle node 305 can interface with the backend stack 405, such as the backend system and services, messaging interfaces, external APIs, and user interfaces via an input adapter. Further, the distributed ledger technologies 110 can also interface with the oracle node 305 via an adapter configured as an output adapter. The adapters can facilitate the transmission of event information and data.

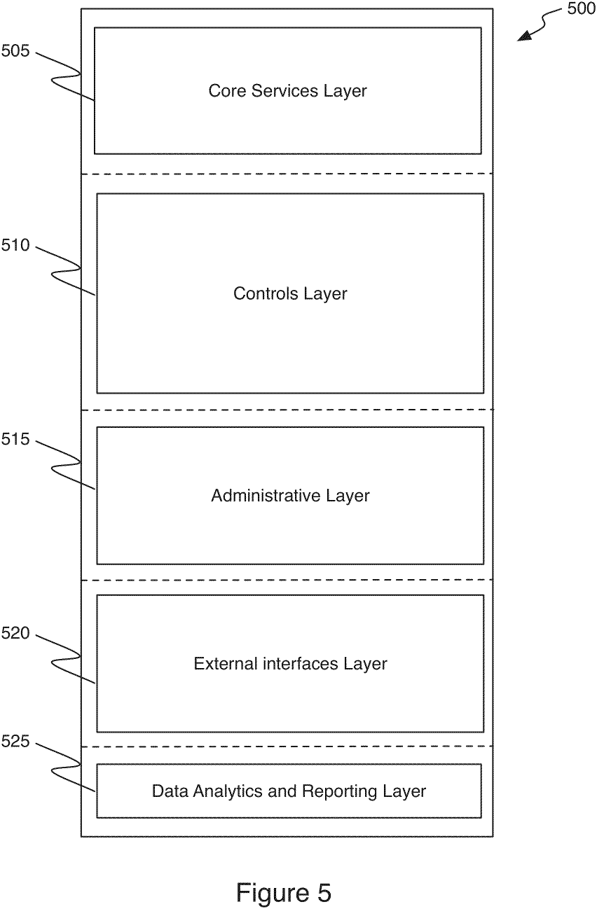

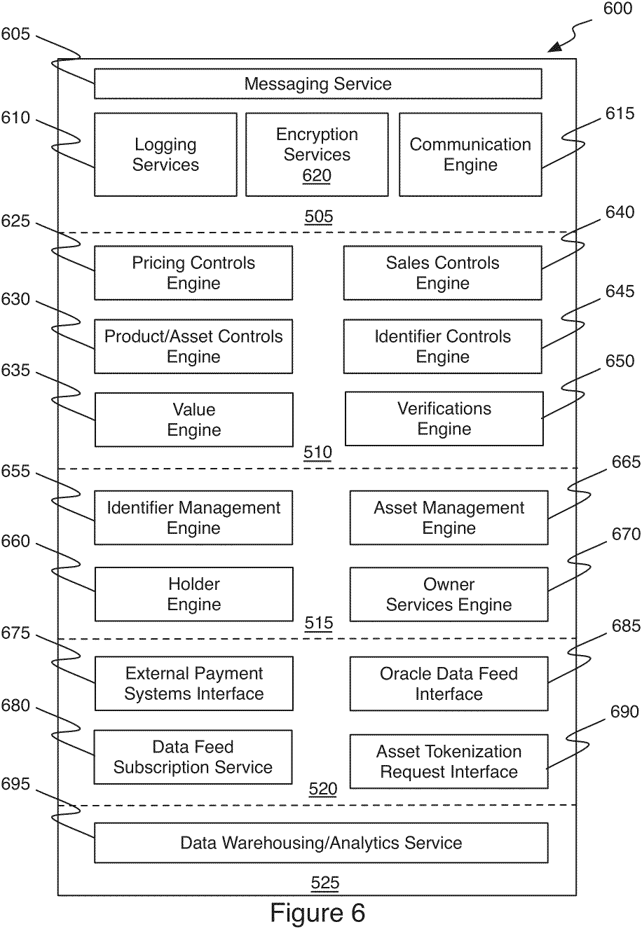

Referring now to FIG. 5 and FIG. 6, in some embodiments, one or more engines or services 500, 600 perform the various operations of the trackable product interest system 100. The core services layer 505 can include, for example, one or more of a messaging service 605, which can include support from a messaging service, such as AWS AppSync, Pinpoint, or Simple Notification Service; a logging service 610, an encryption services 620 which may include support from a encryption key management service such as AWS Key Management Service; and a communication engine 615, which may include support from a content delivery network such as AWS CloudFront, and a managed service for creating, publishing, maintaining, monitoring, and securing APIs at scale, such as AWS API Gateway. The controls layer 510 can include one or more of a pricing controls engine 625, a product/asset controls engine 630, a value engine 635, a sales control engine 640, an identifier controls engine 645, and a verifications engine 650, one or more of which may include support from a serverless compute service such as AWS Lambda, an object storage solution such as Amazon S3, and a database, such as an AWS DynamoDB key-value document database. In some instance, an administrative layer 515 includes one or more of an identifier management engine 655, a holder engine 660, an asset management engine 665, and an owner services engine 670, all of which can include support from one or more of a database, such as an AWS DynamoDB key-value document database, a data stream management service, such as AWS Kinesis Firehose, and a messaging service, such as AWS Simple Notification Service. In some implementations, an external interfaces layer 520 includes one or more of an external payment systems interface 675, a data feed subscription service 680, an oracle data feed interface 685, and an asset tokenization request interface 690, all of which can include support from one or more of a database, such as an AWS DynamoDB key-value document database, a data stream management service, such as AWS Kinesis Firehose 180, a messaging service, such as AWS Simple Notification Service., a serverless compute service such as AWS LambdaTM, a managed message queueing services such as AWS Simple Queue Service, and object and data storage for operations involving, for example, token and asset information warehousing, such as Amazon S3. In some embodiments, a data warehousing/analytics layer 695 provides one or more of data warehousing, data aggregation, data derivation, and data analytics services and operations.

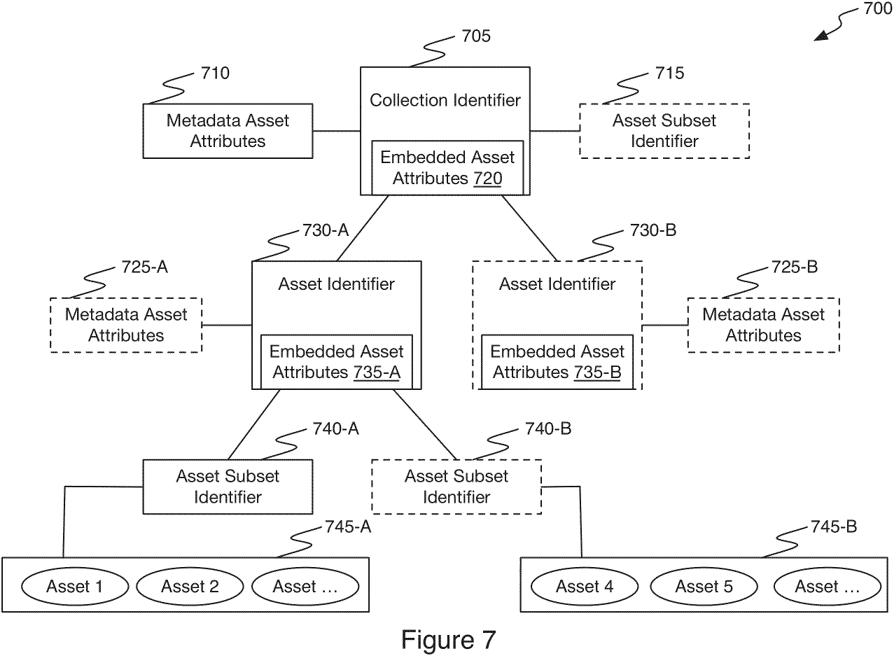

Referring to FIG. 7, one or more assets can be defined by a hierarchy of identifiers 700 and can be monetized through the trackable product interest system 100. A collection identifier object 705 can hold a collection of other identifier objects, collection identifier objects, or both. This collection identifier object 705 can be associated with a collectable identifier symbol, such as a string or scannable symbols. A portion of the symbol can include one or more embedded asset attributes 720 representative of a subset of the assets represented by the set of identifier objects in the collection identifier object 705.

The collection identifier object 705 can further be associated directly with metadata asset attributes 710, asset subsets via an asset subset identifier 715, or both. Metadata asset attributes can include any information appliable to one or more assets where that metadata asset attribute can be used to identify a subset of the assets represented by the set of identifier objects in the collection identifier object 705. A collection identifier object 705 can hold a collection of other identifier objects, collection identifier objects, or both. The asset identifier object 730 can be associated with a symbol, such as a string. All or a portion of the symbol can include one or more embedded asset attributes representative of a subset of the assets represented by the set of identifier objects in the collection identifier object 705.

An asset identifier object 730 can hold a collection of asset subset identifier objects 740, collection identifier objects, or both. This asset identifier object 730 can be associated with an asset identifier symbol, such as a string or scannable symbol. A portion of the symbol can include one or more embedded asset attributes 735 representative of a subset of the assets represented by the set of identifier objects in the asset identifier object 730.

The asset identifier object 730 can further be associated directly with metadata asset attributes 725. Metadata asset attributes can include any information applicable to one or more assets where that metadata asset attribute can be used to identify a subset of the assets represented by the set of identifier objects in the asset identifier object 730. An asset identifier object 730 can hold one or more asset subset identifier objects 740. The asset identifier object 730 and the asset subset identifier object 740 can be associated with a symbol, such as a string. All or a portion of the symbol can include one or more embedded asset attributes representative of a subset of the assets represented by the set of identifier objects in the asset identifier object 730. The asset subset identifier object 740 can include one or more designated assets 745-A, 745-B. The hierarchical model can one or more of simplify the data model complexity typically associated with product tracking, and reduce the memory demands, bandwidth demands, or both, associated with tracking products and services across the supply chain, and in particular, with tracking products and service across that supply chain that are associated with identifiers representing subsequent contractual obligations, such as payment distribution obligations.

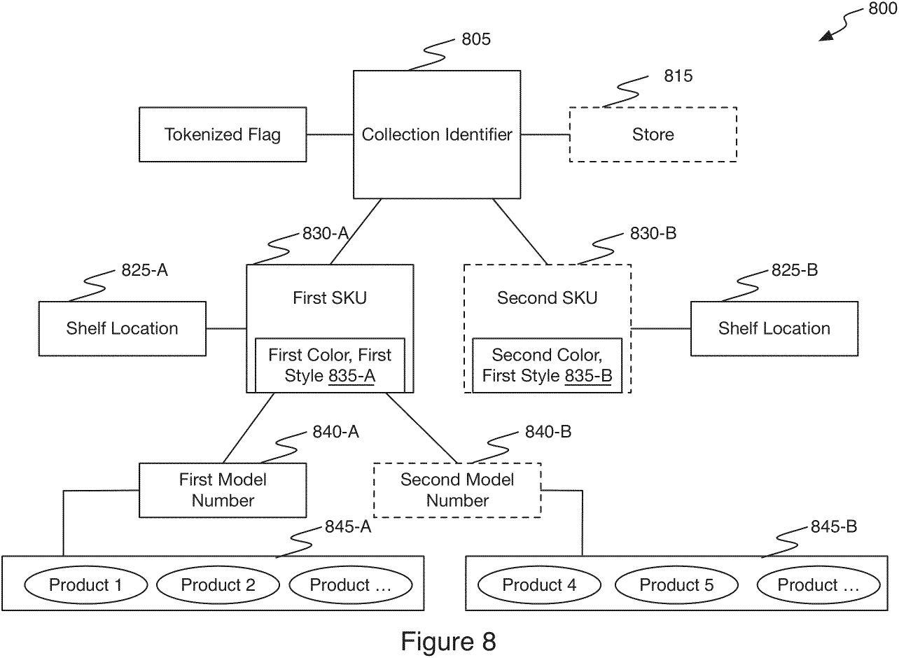

Referring to FIG. 8, a SKU-centric asset identification scheme can be implemented based on the hierarchy of identifiers described in FIG. 7 previously. As an example, a collection identifier 805 could be used to identify a subset of store products 845 at a subset of store locations. An asset subset identifier object is used in this example to identify a particular store 815, thus creating a subset identification of a set of stores products to just products at a particular location. Next, asset identifier objects 830 are used to indicate particular SKU’s associated with particular products. These SKU objects are further associated with metadata asset attributes 825 that provide indication of a particular shelf location. This shelf location metadata could be used in conjunction with shelf monitoring and reporting technologies to, for example, identify a subset of products located at a specific shelf location, provide verification of contracted-for shelf location, or both. A portion of the SKU number could serve as an embedded asset attribute, indicating a particular product attribute such as a color, a style, or the like 835, thus identifying a further subset of the products. A model number, manufacturer part number, or the like 840, can be associated with the SKU object as an asset subset identifier, identifying a further subset of the assets, in this case, store products.

In some instances, the collection identifier symbol is included on or with the product such that product events can be detected where the collection identifier is detected in association with the product event, such as a purchase, and then transmitted to a receiver component of the backend system and services 105. In other instances, the collection identifier is not included on or with the product. Alternatively, the SKU is detected in association with the product event, then the SKU and event are transmitted to the backend system and services 105. The one or more engines then process the SKU to determine to which collection identifier object subsets it belongs. The collection identifier object can further be associated with a tokenization flag 810 where a true value indicates that the collection identifier is tokenized and may have associated contractual or payment obligations based on the product events detected.

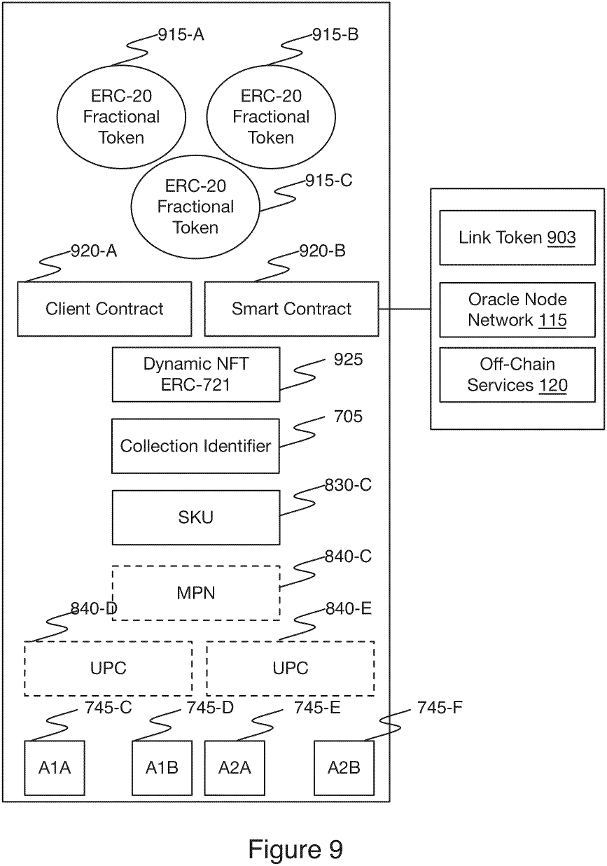

Referring to FIG. 9, the asset identification scheme implemented based on the hierarchy of identifiers described in FIG. 7 can be further associated with tokenization activity to allow for the monetization of the asset collections. A collection identifier 925 can represent a subset of a business’s products 745-C, 745-D, 745-E, 745-F, in this case defined at least in part by a SKU 935, an MPN 940, and optionally one or more UPC’s. The collection identifier is then tokenized, such as through the minting of a dynamic NFT as an ERC-721 token 925, which can then be further fractionalized through the creation of one or more ERC-20 fractional tokens 915. The client contract and smart contract 920 can be implemented, with the smart contract interacting with a link token 903, which is an ERC-677 token as an extension of ERC-20. The link tokens 903 act as data payloads, feeding the required data from off-chain sources to smart contracts, which then act accordingly in response to the data provided by the token.

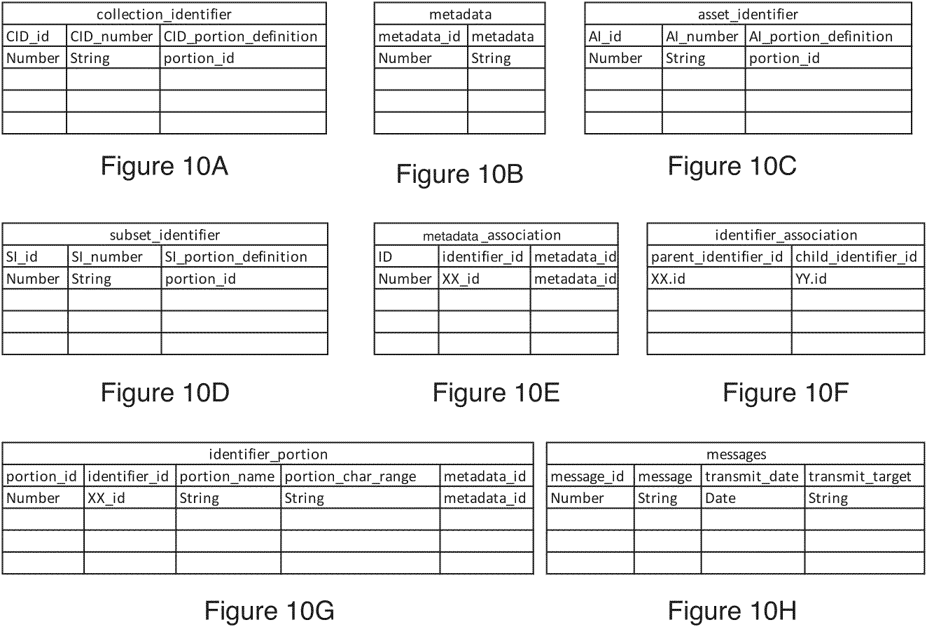

Referring to FIG. 10A, in some instances, a collection_identifier table includes attributes such as:

| | |
|---|---|
| CID_id | Unique identifier |
| CID_number | Collection identifier symbol or string |
| CID_portion_definition | portion_id from the identifier_portion table |

Referring to FIG. 10B, in some instances, a metadata table includes attributes such as:

| | |
|---|---|
| metadata id | Unique identifier |
| metadata | Asset associated metadata |

Referring to FIG. 10C, in some instances, an asset_identifier table includes attributes such as:

| | |
|---|---|
| AI_id | Unique identifier |
| AI_number | Asset identifier symbol or string |
| AI_portion_definition | Porition_id from the identifier_portion table |

Referring to FIG. 10D in some instances, a subset identifier table includes attributes such as:

| | |
|---|---|
| SI_id | Unique identifier |
| SI_number | Subset identifier symbol or string |
| SI_portion_definition | Porition_id from the identifier_portion table |

Referring to FIG. 10E in some instances, a metadata_association table includes attributes such as:

| | |
|---|---|
| ID | Unique identifier |
| identifier_ID | ID from the collection _identifier table, the asset_identifier table, or the subset_identifier table |
| metadata_ID | ID from the metadata table |

Referring to FIG. 10F in some instances, a identifier_association table includes attributes such as:

| | |
|---|---|
| parent_identifier_id | ID from the collection _identifier table, the asset_identifier table, or the subset_identifier table that is a parent of another identifier record |
| child identifier id | ID from the collection _identifier table, the asset_identifier table, or the subset_identifier table that is a child of another identifier record |

Referring to FIG. 10G in some instances, a identifier_portion table includes attributes such as:

| | |
|---|---|
| portion_id | Unique ID |
| identifier id | ID from the collection _identifier table, the asset_identifier table, or the subset_identifier table |
| portion_name | Display name for the portion |
| portion_char_range | Character range or other range definition of the portion |
| metadata id | ID from the metadata table |

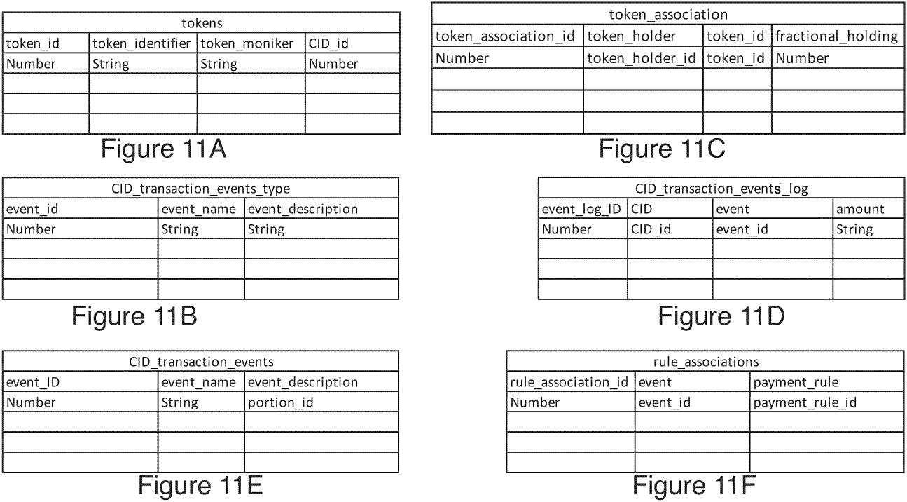

Referring to FIG. 11A in some instances, a tokens table includes attributes such as:

| | |
|---|---|
| token id | Unique ID |
| token_identifier | Token system identifier |
| token moniker | Display name for the token |
| CID_id | ID for a collection identifier |

Referring to FIG. 11B in some instances, a CID_transaction_events_type table includes attributes such as:

| | |
|---|---|
| event id | Unique ID |
| event_name | Display name for the event |
| event_description | Description of the event |

Referring to FIG. 11C in some instances, a token_association table includes attributes such as:

| | |
|---|---|
| token_association_id | Unique ID |
| token_holder | Current owner of the token |
| token_id | token_id from the tokens table |
| fractional_holding | Fractional amount of the asset interest represented by the token |

Referring to FIG. 11D in some instances, a CID_transactions_event_log table includes attributes such as:

| | |
|---|---|
| event_log_ID | Unique ID |
| CID | CID_id from collection identifier table |
| event | Event_id from the CID_transaction_events_type table |
| amount | Event value |

Referring to FIG. 11E in some instances, a CID_transactions_event table includes attributes such as:

| | |
|---|---|
| event_id | Unique ID |
| event_name | Display name for the transaction event |
| event | Description of the transaction event |

Referring to FIG. 11F in some instances, a rule_associations table includes attributes such as:

| | |
|---|---|
| rule_associations_id | Unique ID |
| event | event_id from the CID_transaction_events_type |
| payment_rule | Payment_rule_id from the payment_calculation_rules table |

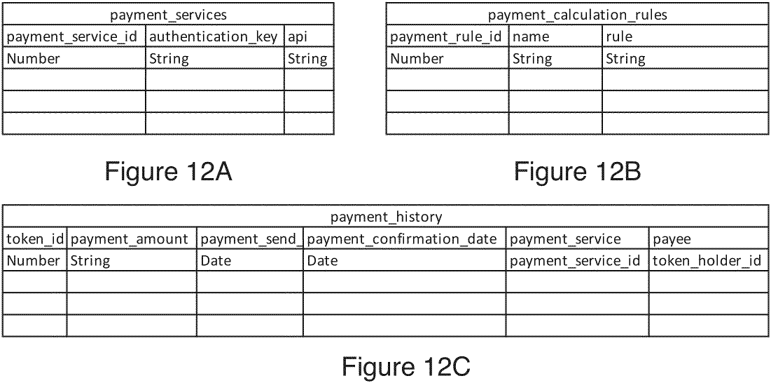

Referring to FIG. 12A in some instances, a payment_services table includes attributes such as:

| | |
|---|---|
| payment_services_id | Unique ID |
| Authentication_key | Authentication key for communicating with payment services system |
| api | API call for communicating with payment services system |

Referring to FIG. 12B in some instances, a payment_calculation_rules table includes attributes such as:

| | |
|---|---|
| payment_rule_id | Unique ID |
| name | Display name for the payment calculation rule |
| rule | Payment calculation rule definition |

Referring to FIG. 12C in some instances, a payment_calculation_rules table includes attributes such as:

| | |
|---|---|
| payment_history_id | Unique ID |
| token id | token_id from the tokens table |
| payment_amount | Amount of payment |
| payment_send | Date payment was initiated/requested |
| payment_confirmation_date | Date payment confirmation was received |
| payment_service | payment_services_id from the payment_services table |
| payee | token_holder_id from the token_association table |

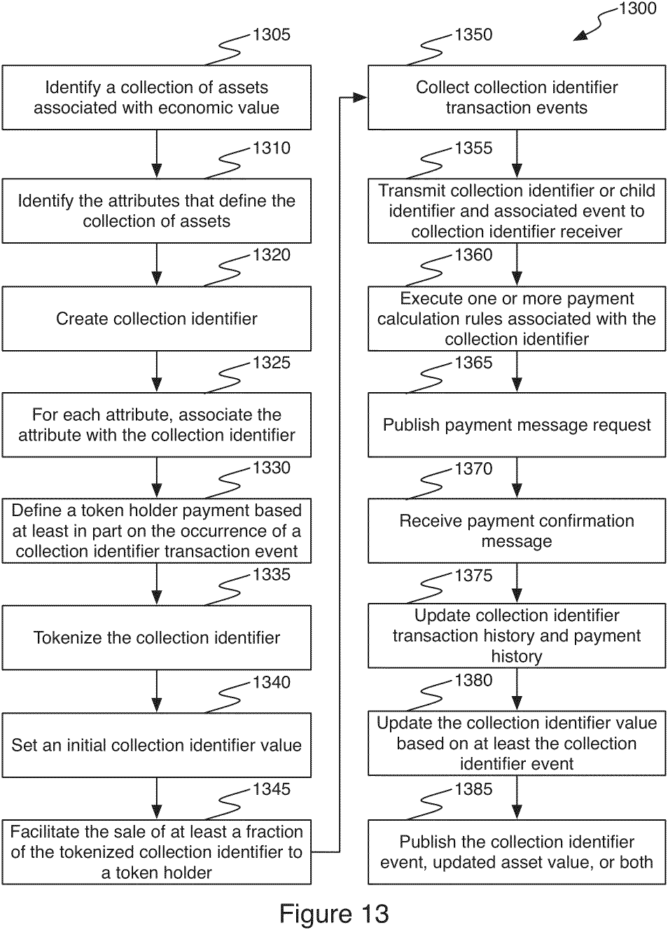

Referring now to FIG. 13, the trackable product interest process 1300 is initiated. In some implementations, one or more assets, such as products or services, are identified that are associated with a non-zero economic value 1305. Attributes of the assets are identified that define a collection of assets 1310. A collection identifier object is created that represents the defined collection 1320. For each attribute the attribute is associated with the collection identifier 1325, such as through one or more of a metadata association, an embedded asset attribute, an asset subset identifier, or the like 1330. The collection identifier is tokenized with the token and collection identifier being associated with an initial collection identifier value 1335, 1340. A sale of at least a fraction of the tokenized collection identifier, such as through an ERC-20 fractional token, to a token holder is facilitated 1345. One or more transaction events associated with the collection of assets is detected and collected 1350. Upon detection and collection, the collection identifier or asset identifier and associated event data are transmitted to an identifier receiver 1355. At some point after receipt of the identifier one or more payment calculation rules associated with the event are executed, and one or more payment request messages are published 1360, 1365. A payment confirmation is received, and the collection identifier history and payment history logs are updated 1370, 1375. The collection identifier value is updated based on at least the collection identifier event 1380. In some instances, additional factors such as market data feed data are included in making this value determination. In some instances, one or more of the collection identifier event details and the updated collection identifier value are published 1385.

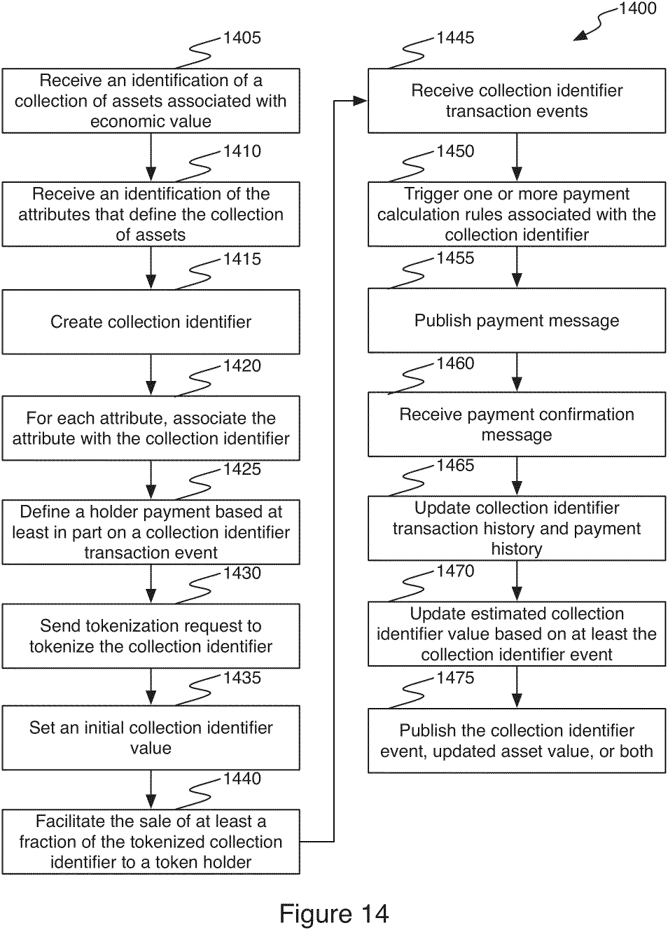

Referring now to FIG. 14, the backend system and services processes 1400 of the trackable product interest process are initiated. In some implementations, an identification of one or more assets, such as products or services, associated with a non-zero economic value are received 1405. An identification of attributes of the assets that define a collection of assets are received 1410. A collection identifier object is created that represents the defined collection 1415. For each attribute the attribute is associated with the collection identifier, such as through one or more of a metadata association, an embedded asset attribute, an asset subset identifier, or the like 1420. A holder payment rule is created based at least in part on a collection identifier transaction event occurrence 1425. A tokenization request is transmitted to tokenize the collection identifier, the collection identifier being associated with an initial collection identifier value 1430, 1435. A sale of at least a fraction of the tokenized collection identifier, such as through an ERC-20 fractional token, to a token holder is facilitated 1440. One or more transaction events associated with the collection of assets are received 1445. At some point after receipt of the identifier one or more payment calculation rules associated with the event are executed, and one or more payment request messages are published 1450, 1455. A payment confirmation is received 1460, and the collection identifier history and payment history logs are updated 1465. The collection identifier value is updated based on at least the collection identifier event 1470. In some instances, additional factors such as market data feed data are included in making this value determination. In some instances, one or more of the collection identifier event details and the updated collection identifier value are published 1475.

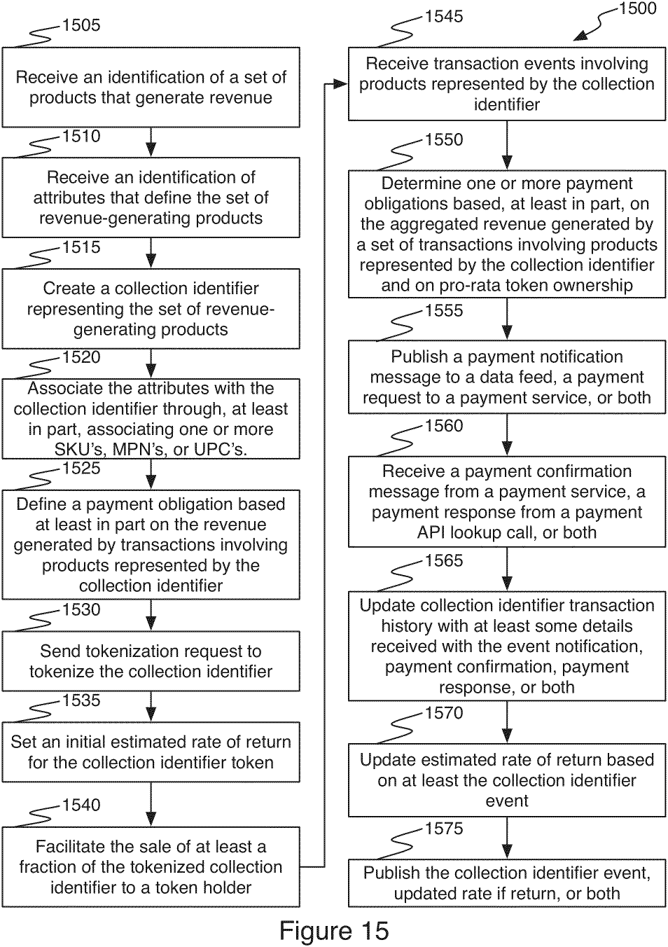

Referring now to FIG. 15, the revenue-generation activity process 1500 in the trackable product interest system is initiated. An identification of a revenue-generating set of products or services is received 1505, and attributes that define the set of revenue-generating products to the exclusion of other products is also received 1510. A collection identifier object representing the set of revenue generating products is created 1515, and at least a portion of the attributes are then associated with the collection identifier object through one or more SKU, MPN, or UPC 1520. One or more contractual obligations, such as payment obligations, are defined based at least in part on the revenue that is generated by transactions or events involving the products represented by the collection identifier object 1525. A tokenization request is sent to a tokenization platform or technology tokenizing the collection identifier object 1530, and an initial estimated value, rate of return, or both, are set for the collection identifier token 1535. A sale to a token holder of at least a fraction of the tokenized collection identifier is facilitated 1540. Transaction events and certain other events associated with the products represented by the collection identifier are received by the trackable product interest system 1545. One or more contractual obligations, such as payment obligations, are determined based, at least in part, on the aggregated revenue generated by a set of transactions involving the product represented by the collection identifier in combination with the pro-rata ownership interest represented by a fractional token 1550. A payment notification message is published to a stream or data feed, a payment request is sent to a payment service, or both 1555. A payment confirmation is received either directly or indirectly from a payment service, as a payment response from a payment API lookup call, or both 1560. The collection identifier transaction history log is updated with at least some portion of the information received with one or more of the event notification, the payment confirmation, or payment response 1565. The estimated rate of return, value, or both are updated based at least in part on the collection identifier event occurrence 1570. In some implementations, one or more of the collection identifier event, the updated rate of return, and the updated value are published to a stream or data feed 1575.

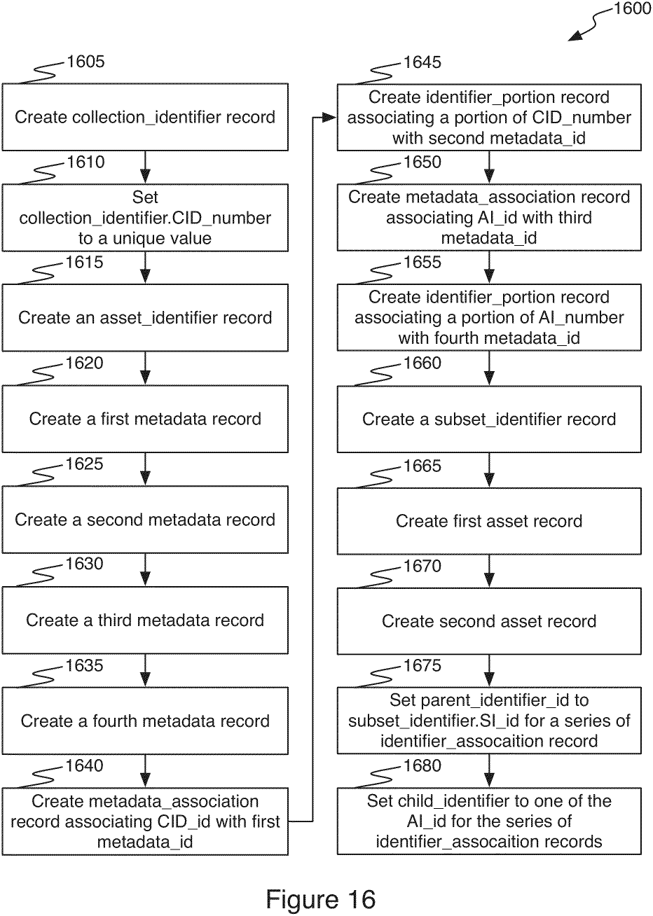

Referring now to FIG. 16, the hierarchical identifier creation process 1600 in the trackable product interest system is initiated. A collection _identifier table record is created by setting collection_identifier.CID_number to a unique value 1605, 1610. An asset_identifier record and a series of metadata records are created 1615, 1620, 1625, 1630 1635. A metadata_association record is created associating the collection _identifier.CID_number with one of the metadata_association records 1640. This is repeated for the other metadata_association records 1645, 1650, 1655. A subset_identifier record is created, and a series of asset_identifier records are created 1660, 1665, 1670. The asset_identifier records are then associated with the subset_identifier record by adding each to the identifier_association table, where the parent_identifier_id for each record is set to the SI_id of the subset identifier record and the child_identifier_id for each record is set to one of the asset_identifier records 1675, 1680.

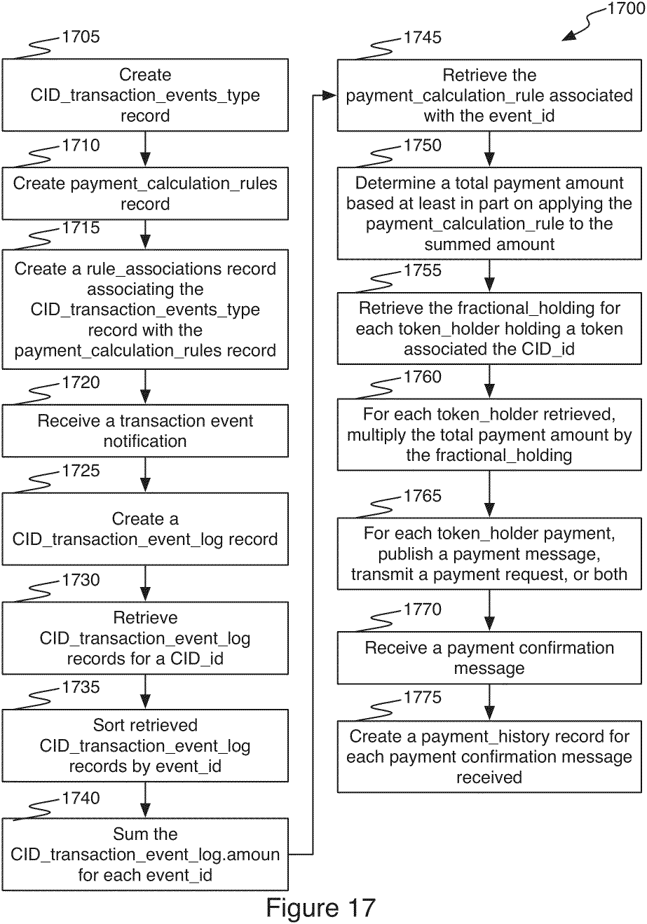

Referring now to FIG. 17, the payment rule process 1700 in the trackable product interest system is initiated. A CID_transaction_events_type record and a payment_calculation_rules record are created 1705, 1710. A rule_associations record associating the CID_transaction_events_type record with the payment_calculation_rules record is then created 1715. When a transaction event notification is received 1720, a CID_transaction_event_log record is created 1725, and CID_transaction_event_log records for a CID_id are retrieved 1730. The list of retrieved records are sorted by event_id, and the sum of the CID_transaction_event_log.amount for each event_id is determined 1735, 1740. The payment_calculation_rule associated with the event_id is retrieved 1745, and the total payment amount based at least in part on applying the payment_calculation_rule to the summed amount is determined 1750. The fractional_holding for each token_holder holding a token associated the CID_id is retrieved 1755, and for each token_holder retrieved, the total payment amount is multiplied by the fractional_holding for that token_holder 1760. For each token_holder payment, a payment notification message is published, a payment request is published, or both 1765. For each payment confirmation received, a payment_history record is created 1770, 1775.

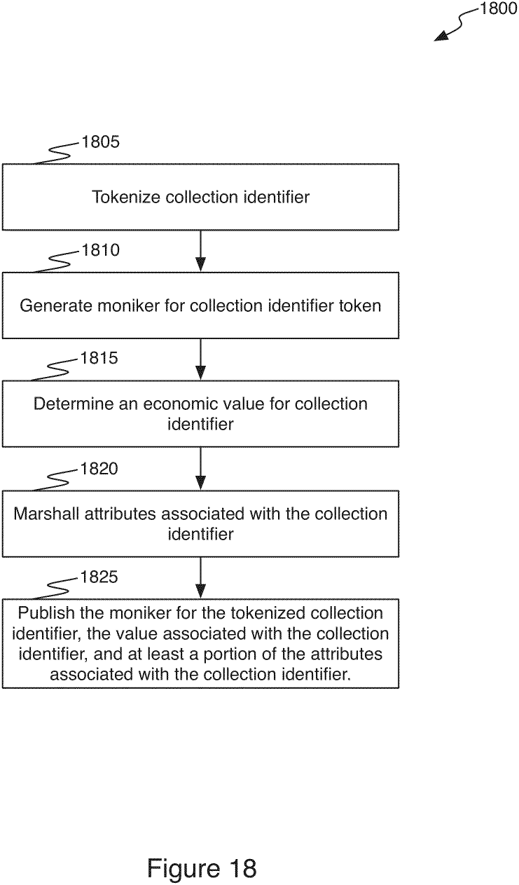

Referring to FIG. 18, the tokenization process 1800 in the trackable product interest system is initiated. A collection identifier is tokenized, such as through making a request to a tokenization platform 1805. A moniker is generated representing the collection identifier token, and an economic value is determined and associated with the collection identifier token 1810, 1815. Attributes associated with the collection identifier are marshalled 1820, and the moniker for the tokenized collection identifier, the value associated with the collection identifier, and at least a portion of the attributes associated with the collection identifier are published 1825.

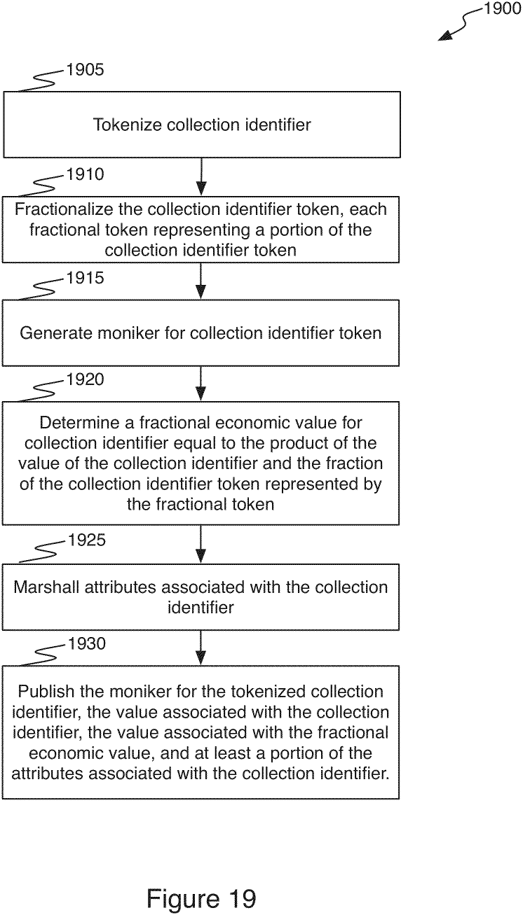

Referring to FIG. 19, the fractional tokenization process 1900 in the trackable product interest system is initiated. A collection identifier is tokenized, such as through making a request to a tokenization platform 1905. The collection identifier token is fractionalized, each fractional token representing a portion of the collection identifier token 1910. A moniker is generated representing the collection identifier token, and a fractional economic value is determined for the collection identifier token equal to the product of the value of the collection identifier and the fraction of the collection identifier token represented by the fractional token 1915, 1920. Attributes associated with the collection identifier are marshalled 1925, and the moniker for the tokenized collection identifier, the value associated with the collection identifier, the value associated with the fractional economic value, and at least a portion of the attributes associated with the collection identifier are published 1930.

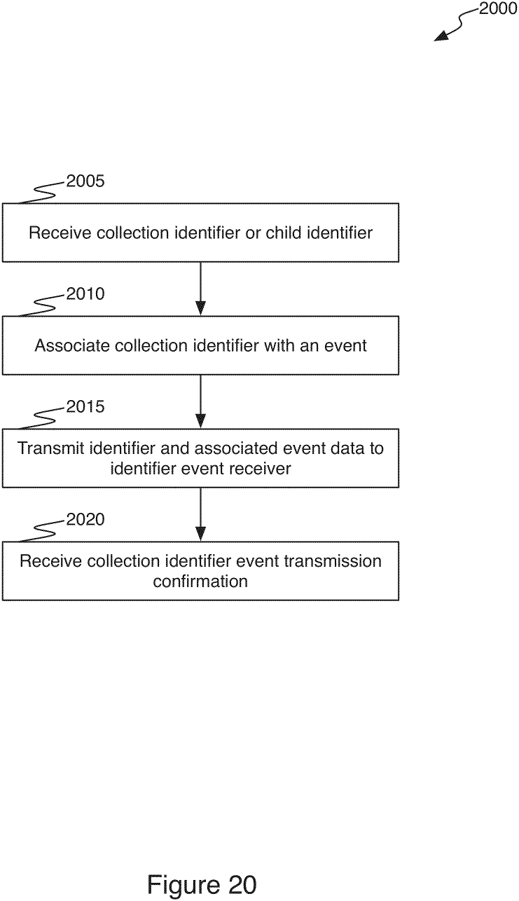

Referring to FIG. 20, the store-related process 2000 of the trackable product interest system is initiated. A collection identifier or asset identifier, such as a SKU, is received at the store, such as from a scanning operation, and associated with a particular event, such as the sale of a product 2005, 2010. The identifier and associated event data are transmitted to an identifier event receiver 2015, and an event transmission receipt confirmation is received 2020.

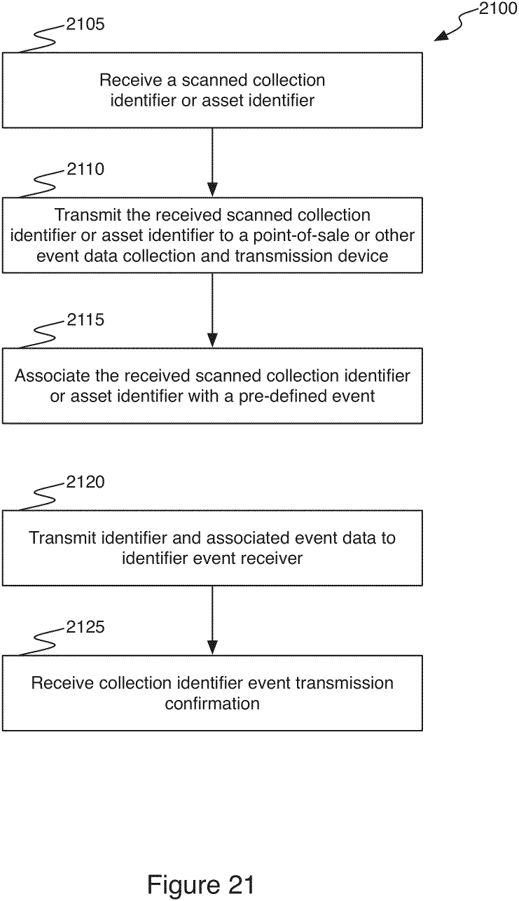

Referring now to FIG. 21, in some instances, at a location associated with a defined event, such as a sale of goods, one or more scanning technologies, such as a barcode scanning device, a SKU scanning device, an RFID reader, or the like, one or more of scans, stores, detects, receives, decodes, and encodes one or more identifiers associated with an event involving a specific product or service 2105. Scanning devices can include, for example, mobile device scanning apps, mobile device RFID reader apps, networked handheld scanning guns, handheld scanning guns with local memory storage, fixed scanning appliances, handheld RFID readers, fixed RFID reader appliances, and the like. In some instances, the scanning or RFID reader device is communicatively coupled to a transmitting or point-of-sale device. The scanning device then transmits the received scanned collection identifier or asset identifier to a point-of-sale or other event data collection and transmission device 2110. If not already performed by the scanning device or other process, the point-of-sale or other event data collection and transmission device associates the received scanned collection identifier or asset identifier with a pre-defined event 2115. The identifier and associated event data are transmitted to an identifier event receiver 2120, and an event transmission receipt confirmation is received 2125.

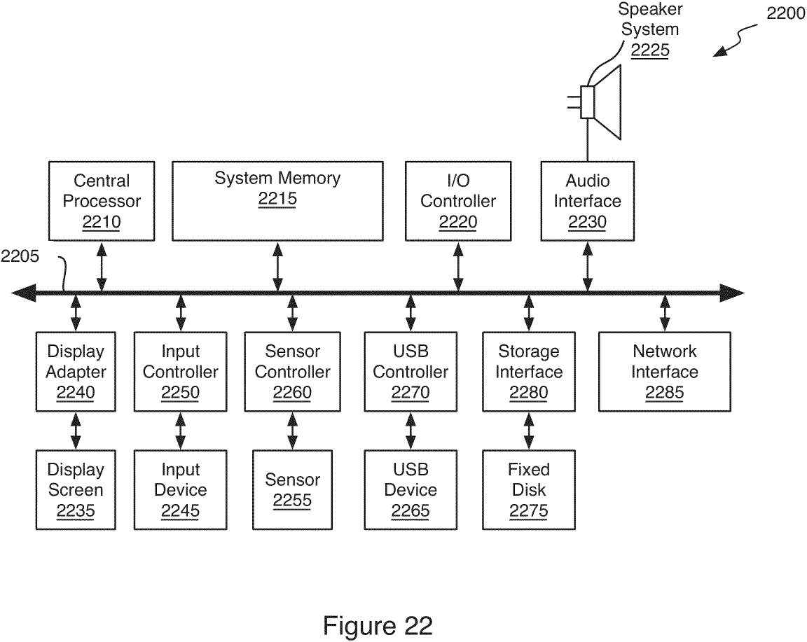

Referring now to FIG. 22, in one configuration, the computing devices 2200 of the trackable product interest system include a bus 2205 which interconnects major subsystems of the computing device, 112, such as a central processor 2210, a system memory 2215 (typically RAM, but which may also include ROM, flash RAM, or the like), an input/output controller 2220, an external audio device, such as a speaker system 2225 via an audio output interface 2230, an external device, such as a display screen 2235 via display adapter 2240, an input device 2245 (e.g., remote control device interfaced with an input controller 2250), one or more USB devices 2265 (interfaced with a USB controller 2270), and a storage interface 2280. In some instances, the computing device 112 includes one or more sensors 2255 connected to bus 2205 through a sensor controller 2260 and a network interface 2285 (coupled directly to bus 2205).

Bus 2205 allows data communication between central processor 2210 and system memory 2215, which may include read-only memory (ROM) or flash memory (neither shown), and random access memory (RAM) (not shown), as previously noted. The RAM is generally the main memory into which the operating system and logic instructions are loaded. The ROM or flash memory may contain, among other code, the Basic Input-Output system (BIOS) which controls basic hardware operation such as the interaction with peripheral components or devices. Instructions resident with the trackable product interest system computing devices are generally stored on and accessed via a non-transitory computer readable medium, such as a solid state drive (e.g., fixed disk drive 2275), a hard disk drive, or other storage medium. Additionally, applications may be in the form of electronic signals modulated in accordance with the application and data communication technology when accessed via network interface 2285.

Storage interface 2280, as with the other storage interfaces of, may connect to a standard computer readable medium for storage and/or retrieval of information, such as a fixed disk drive 2275. Fixed disk drive 2275 may be a part of computing device 2200 or may be separate and accessed through other interface systems. Network interface 2285 may provide a direct connection to a remote server computing device via a direct network link to the Internet. Network interface 2285 may provide such connection using wireless techniques, including broadband, digital cellular telephone connection, Cellular Digital Packet Data (CDPD) connection, digital satellite data connection, or the like. In some embodiments, one or more sensors connect to computing device 2200 wirelessly via network interface 2285.

Many other devices or subsystems (not shown) may be connected in a similar manner. Conversely, all of the devices shown in FIG. 22 need not be present to practice the present systems and methods. The devices and subsystems may be interconnected in different ways from that shown in FIG. 22. The aspect of some operations of a system such as that shown in FIG. 22 are readily known in the art and are not discussed in detail in this application. Computer instructions to implement the present disclosure may be stored in a non-transitory computer-readable medium such as one or more of system memory 2220 or fixed disk drive 2275. The operating system provided on computing device 2200 may be, for example, iOS®, ANDROID®, MS-WINDOWS®, UNIX®, LINUX®, OSX®, or another known operating system.

Conditional language, such as “can,” “could,” “might,” or “may,” unless specifically stated otherwise, or otherwise understood within the context as used, is generally intended to convey that certain implementations include or do not include, certain features, elements, and/or steps. Thus, such conditional language is not generally intended to imply that features, elements, and/or steps are in any way required for one or more implementations.

Conjunctive language, such as the phrase “at least one of X, Y, and Z.” unless specifically stated otherwise, is otherwise understood with the context as used in general to convey that an item, term, etc. may be either X, Y, or Z. Thus, such conjunctive language is not generally intended to imply that certain implementations require the presence of at least one of X, at least one of Y, and at least one of Z.

Several illustrative implementations of trackable product interest system have been disclosed. Although this disclosure has been described in terms of certain illustrative implementations and uses, other implementations and other uses, including implementations and uses which do not provide all of the features and advantages set forth herein, are also within the scope of this disclosure. Components, elements, features, acts, or steps can be arranged or performed differently than described and components, elements, features, acts, or steps can be combined, merged, added, or left out in various implementations. All possible combinations and subcombinations of elements and components described herein are intended to be included in this disclosure. No single feature or group of features is necessary or indispensable.

Certain features that are described in this disclosure in the context of separate embodiments can also be implemented in combination in a single embodiment. Conversely, various features that are described in the context of a single implementation also can be implemented in multiple embodiments separately or in any suitable subcombination. Moreover, although features may be described above as acting in certain combinations, one or more features from a claimed combination can in some cases be excised from the combination, and the combination may be claimed as a subcombination or variation of a subcombination.

Any portion of any of the steps, processes, structures, and/or devices disclosed or illustrated in one implementation or example in this disclosure can be combined or used with (or instead of) any other portion of any of the steps, processes, structures, and/or devices disclosed or illustrated in a different implementation, flowchart, or example. The implementations and examples described herein are not intended to be discrete and separate from each other. Combinations, variations, and some implementations of the disclosed features are within the scope of this disclosure.

While operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Additionally, the operations may be rearranged or reordered in some implementations. Also, the separation of various components in the implementations described above should not be understood as requiring such separation in all implementations, and it should be understood that the described components and systems can generally be integrated together in a single product or packaged into multiple products. Additionally, some implementations are within the scope of this disclosure.

Further, while illustrative embodiments have been described, any implementations having equivalent elements, modifications, omissions, and/or combinations are also within the scope of this disclosure. Moreover, although certain aspects, advantages, and novel features are described herein, not necessarily all such advantages may be achieved in accordance with any particular implementation. For example, some implementations within the scope of this disclosure achieve one advantage, or a group of advantages, as taught herein without necessarily achieving other advantages taught or suggested herein. Further, some implementations may achieve different advantages than those taught or suggested herein.

Additionally, any methods described herein may be practiced using any device suitable for performing the recited steps.

In summary, various implementations and examples of trackable product interest system systems and related methods have been disclosed. This disclosure extends beyond the specifically disclosed implementations and examples to other alternative implementations and/or other uses of the implementations, as well as to certain modifications and equivalents thereof. Moreover, this disclosure expressly contemplates that various features and aspects of the disclosed implementations can be combined with, or substituted for, one another. Accordingly, the scope of this disclosure should not be limited by the particular disclosed implementations described above, but should be determined only by a fair reading of the claims

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present systems and methods and their practical applications, to thereby enable others skilled in the art to best utilize the present systems and methods and various embodiments with various modifications as may be suited to the particular use contemplated.

Unless otherwise noted, the terms “a” or “an,” as used in the specification are to be construed as meaning “at least one of.” In addition, for ease of use, the words “including” and “having,” as used in the specification, are interchangeable with and have the same meaning as the word “comprising.” In addition, the term “based on” as used in the specification is to be construed as meaning “based at least upon.”

What is claimed is:

1. A computer implemented process for automating raising capital with scanned asset identifiers, the process comprising:
with a computing system and a scanner in communication with the computing system, scanning into storage in the computing system an asset identifier for an asset comprising a product and/or service provided by a product or service providing entity;
with the computing system, automatically storing into storage in the computing system an association between the asset and the asset identifier; and
with the computing system, automatically offering for sale at least a portion of an asset identifier ownership along with at least a percentage interest in subsequent sale revenue or other value derived from the asset as applicable.

2. A computer implemented process for automating raising capital of claim 1 wherein the offering for sale includes providing an associated contractual obligation of delivery to or for a purchaser the percentage interest of subsequent sale revenue or other derived asset value.

3. A computer implemented process for automating raising capital of claim 1 further comprising:
with the computing system, upon an occurrence of a sale of the at least a portion of the asset identifier, providing to the product or service providing entity at least an apportionment of the subsequent sale revenue or other value for the sale.

4. A computer implemented process for automating raising capital of claim 2 further comprising:
with the computing system, upon an occurrence of a sale of the at least a portion of the asset identifier, providing to the product or service providing entity at least an apportionment of the subsequent sale revenue or other value for the sale.

5. A computer implemented process for automating raising capital of claim 1 where the asset identifier includes a barcode or an SKU.

6. A computer implemented process for automating raising capital of claim 2 where the asset identifier includes a barcode or an SKU.

7. A computer implemented process for automating raising capital of claim 3 where the asset identifier includes a barcode or an SKU.

8. A computer implemented process for automating raising capital of claim 4 where the asset identifier includes a barcode or an SKU.

9. A computer implemented process for automating raising capital of claim 5 where the asset identifier includes a barcode or an SKU.

10. A computer implemented process for automating raising capital of claim 1 wherein a non-fungible token comprises the at least a portion of the asset identifier ownership along with at least a percentage interest in subsequent sale revenue or other derived asset value as applicable.

11. A computer implemented process for automating raising capital of claim 2 wherein a non-fungible token comprises the at least a portion of the asset identifier ownership along with at least a percentage interest in subsequent sale revenue or other value derived from the asset as applicable.

12. A computer implemented process for automating raising capital of claim 4 wherein a non-fungible token comprises the at least a portion of the asset identifier ownership along with at least a percentage interest in subsequent sale revenue or other value derived from the asset as applicable.

13. A computer implemented process for automating raising capital of claim 5 wherein a non-fungible token comprises the at least a portion of the asset identifier ownership along with at least a percentage interest in subsequent sale revenue or other value derived from the asset as applicable.

14. A computer implemented process for automating raising capital of claim 9 wherein a non-fungible token comprises the at least a portion of the asset identifier ownership along with at least a percentage interest in subsequent sale revenue or other value derived from the asset as applicable.

15. A computer implemented process for automating raising capital of claim 1 wherein a blockchain cryptographic system stores the at least a portion of the asset identifier ownership along with at least a percentage interest in subsequent sale revenue or other value derived from the asset as applicable.

16. A computer implemented process for automating raising capital of claim 2 wherein a blockchain cryptographic system stores the contractual obligation along with the at least a portion of the asset identifier ownership along with at least a percentage interest in subsequent sale revenue or other value derived from the asset as applicable.

17. A computer implemented process for automating raising capital of claim 4 wherein a blockchain cryptographic system stores the contractual obligation in the at least a portion of the asset identifier ownership along with at least a percentage interest in subsequent sale revenue or other value derived from the asset as applicable.

18. A computer implemented process for automating raising capital of claim 5 wherein a blockchain cryptographic system stores the at least a portion of the asset identifier ownership along with at least a percentage interest in subsequent sale revenue or other value derived from the asset as applicable.

19. A computer implemented process for automating raising capital of claim 6 wherein a blockchain cryptographic system stores the at least a portion of the asset identifier ownership along with at least a percentage interest in subsequent sale revenue or other value derived from the asset as applicable.

20. A computer implemented process for automating raising capital of claim 9 wherein a blockchain cryptographic system stores a contractual obligation in the at least a portion of the asset identifier ownership along with at least a percentage interest in subsequent sale revenue or other value derived from the asset as applicable.

21. A computer implemented process for automating raising capital of claim 3 also including publishing to a data stream or data feed a rate of return to the product or service providing entity for the at least an apportionment of the sale revenue or other value for the sale.

22. A computer implemented process for automating raising capital of claim 4 also including publishing to a data stream or data feed a rate of return to the product or service providing entity for the at least an apportionment of the sale revenue or other value for the sale.

23. A computer implemented process for automating raising capital of claim 7 also including publishing to a data stream or data feed a rate of return to the product or service providing entity for the at least an apportionment of the sale revenue or other value for the sale.

24. A computer implemented process for automating raising capital of claim 8 also including publishing to a data stream or data feed a rate of return to the product or service providing entity for the at least an apportionment of the sale revenue or other value for the sale.

25. A computer implemented process for automating raising capital of claim 10 also including publishing to a data stream or data feed a rate of return to the product or service providing entity for the at least an apportionment of the sale revenue or other value for the sale.

26. A computer implemented process for automating raising capital of claim 11 also including publishing to a data stream or data feed a rate of return to the product or service providing entity for the at least an apportionment of the sale revenue or other value for the sale.

27. A computer implemented process for automating raising capital of claim 12 also including publishing to a data stream or data feed a rate of return to the product or service providing entity for the at least an apportionment of the sale revenue or other value for the sale.

28. A computer implemented process for automating raising capital of claim 15 also including publishing to a data stream or data feed a rate of return to the product or service providing entity for the at least an apportionment of the sale revenue or other value for the sale.

29. A computer implemented process for automating raising capital of claim 16 also including publishing to a data stream or data feed a rate of return to the product or service providing entity for the at least an apportionment of the sale revenue or other value for the sale.

30. A computer implemented process for automating raising capital of claim 20 also including publishing to a data stream or data feed a rate of return to the product or service providing entity for the at least an apportionment of the sale revenue or other value for the sale.
